(19) United States
(12) Patent Application Publication
(10) Pub. No.: US 2025/0042825 A1
(43) Pub. Date: Feb. 6, 2025

(54) FERTILIZER COMPOSITIONS PREPARED FROM NATURAL GAS FEEDSTOCK AND METHODS RELATED THERETO

(71) Applicant: SAUDI ARABIAN OIL COMPANY, Dhahran (SA)

(72) Inventor: Harry Daniel ORDURO, Dhahran (SA)

(73) Assignee: SAUDI ARABIAN OIL COMPANY, Dhahran (SA)

(21) Appl. No.: 18/364,172

(22) Filed: Aug. 2, 2023

(51) Int. Cl. C05F 11/02; C05G 1/00

(52) U.S. Cl. CPC C05F 11/02; C05G 1/00

(57) ABSTRACT

Compositions and methods of a fertilizer comprising humic substances derived from coal extracts; and a high-nitrogen/high-sulfur containing (HNHS) natural gas. The fertilizer composition comprises humic substances present in the range of about 50 wt % to about 60 wt % of the total fertilizer composition, nitrogen present in the range of about 11 wt % to about 14 wt % of the total fertilizer composition, and sulfur present in the range of about 15 wt % to about 17 wt % of the total fertilizer composition.

### FIELD OF THE DISCLOSURE

Embodiments in accordance with the present disclosure generally relate to fertilizer compositions and methods related thereto and, more particularly, to fertilizer compositions prepared from natural gas feedstock and methods related thereto.

### BACKGROUND OF THE DISCLOSURE

Plants obtain most of their nutrients by slow extraction of minerals from soil or water. Plants need macronutrients in large amounts, such as phosphorus (P), potassium (K), calcium (Ca), sulfur(S), and nitrogen (N), which can be sourced from natural extraction of terrestrial minerals and/or the atmosphere.

The natural supply of these plant nutrients, particularly those derived from soil, however, are in increasingly short supply due to, for example, urbanization, industrialization, deforestation, and soil degradation, leading to soil loss in fertility and associated loss in crop productivity. Moreover, a goal of modern farming is procurement of maximum product per unit area of land by planting the same crops in the same ground annually; this further prohibits soil from naturally replenishing minerals necessary for plant growth.

To combat the growing soil nutrient shortage, the use of alternative secondary sources of natural and sustainable chemical products, such as fertilizers, have offered promising means to provide needed nutrients to plants and improve crop productivity to meet global food demands. Fertilizer includes inorganic or organic material of natural or synthetic origin added to soil to supply one or more plant nutrients, such as those described above, essential for the growth of plants or crops.

Inorganic fertilizers enjoy a far larger market share compared to organic fertilizers. Inorganic fertilizers provide a fast dose of nutrients and are fully artificial. Inorganic fertilizers are an effective source of nutrients for plants, are perfectly dosed, and inexpensive. However, inorganic fertilizers can be detrimental to soil. Indeed, inorganic fertilizers can upset the soil of entire plant ecosystems, creating toxic buildup of chemicals and long-term changes in pH, increasing pest infestations, and releasing greenhouse gases. On the other hand, organic fertilizers are comparatively more expensive, and thus less prevalent, but advantageously release nutrients as they break down via microorganisms, thereby improving the soil and its ability to hold water and nutrients. Organic fertilizers pose little or none of the disadvantages of inorganic fertilizers.

Given the aforementioned, there is a need for affordable and sustainable commodity organic fertilizers to promote plant growth and crop productivity to meet global food demands, without depleting soil nutrient resources.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a fertilizer composition is provided including humic substances derived from coal extracts and a high-nitrogen/high-sulfur containing (HNHS) natural gas. The humic substances are present in the range of about 50 wt % to about 60 wt % of the total fertilizer composition, nitrogen is present in the range of about 11 wt % to about 14 wt % of the total fertilizer composition, and sulfur is present in the range of about 15 wt % to about 17 wt % of the total fertilizer composition.

According to an embodiment consistent with the present disclosure, a method is provided including reacting humic substances derived from coal extracts with a high-nitrogen/high-sulfur (HNHS) containing natural gas in the presence of an iron compound, thereby producing the fertilizer composition.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, as will occur to one having ordinary skill in the art and having the benefit of this disclosure.

FIG. 1 illustrates the biochemical pathways of sulfur and nitrogen uptake from the soil and assimilation in plants.

FIG. 2 illustrate a Batch-scale laboratory system for use in preparing humnisul fertilizer, according to one or more aspects of the present disclosure.

FIG. 3 illustrates a reaction scheme related to the preparation of humnisul fertilizer, according to one or more aspects of the present disclosure.

FIG. 4 illustrates a reaction scheme related to the preparation of humnisul fertilizer, according to one or more aspects of the present disclosure.

FIG. 5A is an environmental scanning electron microscopy image of humic substances derived from coal extracts, according to one or more aspects of the present disclosure.

FIG. 5B is an environmental scanning electron microscopy image of humnisul fertilizer, according to one or more aspects of the present disclosure.

### DETAILED DESCRIPTION

Embodiments of the present disclosure, in some instances, will be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to fertilizer compositions and methods related thereto and, more particularly, to fertilizer compositions prepared from natural gas feedstock and methods related thereto.

The present disclosure provides a sustainable, organic nutrient fertilizer fabricated from the reaction of humic acid, fulvic acid, and/or humin extracts (“humic substances”) derived from coal, and reactive sulfur(S) and nitrogen (N) species derived from high nitrogen/high sulfur (HNHS) natural gas feedstock. HNHS natural gas feedstocks are generally considered impurities and waste components produced from natural gas processes. The embodiments described herein utilize these otherwise waste products to prepare fertilizer.

As used herein, the term “humnisul fertilizer” is used to refer to the Humic Nitrogen-Sulfur fertilizer of the present disclosure. The humnisul fertilizer is prepared from the aforementioned waste products and mediated by iron sulfide and iron nitride fixation. The humnisul fertilizer has a circumneutral to slightly alkaline pH, and offers various agronomic advantages compared to conventional fertilizer technologies. The humnisul fertilizer further enhances the healthy growth of crops (e.g., maize) in high pH, arid soils.

Indeed, soils in many arid and desert regions (e.g., the Western United State, Brazil, Asia, Africa, and the Middle East) suffer from excessively high pH, which usually deteriorates soil health and suppresses plant intake of essential nutrients, thereby impeding plant growth. Sulfur and nitrogen application to plants in these high alkaline soil environments can improve plant roots and provide nutrients necessary to produce bountiful crops (e.g., food crops). Grains, fruits, vegetables, and pasture crops require sulfur and nitrogen to sustain growth and high quality crop yields.

Nitrogen and sulfur deficiencies can limit crop growth, yield, and quality. Nitrogen is an essential nutrient important for a variety of cercal and grain growth, as well as protein biosynthesis in many plants. Sulfur is essential for the biosynthesis of amino acids, proteins, and chlorophyll. More importantly, sulfur is a key constituent of enzymes involved in nitrogen metabolism and sulfur deficiency can decrease nitrogen assimilation in plants. Without an adequate supply of sulfur, many grains (e.g., maize, wheat, and rice) cultivated in high pH environments are unable to reach their full yield potential and cannot efficiently utilize nitrogen for protein biosynthesis.

Plants mainly assimilate both nitrogen and sulfur to form a variety of amino acids. Cysteine and methionine are the major amino acid end-products of sulfur assimilation. These amino acids comprise up to 90% of the total sulfur of most plants, and are present predominantly in protein. Other non-protein fractions usually contain glutathione as a major sulfur constituent, together with smaller amounts of sulfur-based amino acid intermediates involved in biosynthesis of the proteins cysteine and methionine (via cysteine, cystathionine, homocysteine, and methionine), and in polyamine synthesis and methyl transfer reactions (through AdoMet, S-adenosylhomocysteine, and 5′-methylthioadenosine).

Compared to HNHS production from natural gas feedstocks, the synthetic-based production of NH₃ from N₂ gas for fertilizer production is a thermodynamically favorable reaction: N₂+3H₂ □NH₃, ΔG=−33 KJ/mol. However, there are major limitations to this reaction due to a strong triple bond, non-polarity, and low proton affinity of N₂, making this a challenging molecule to activate and react efficiently through the Haber-Bosch process. Currently, the Haber-Bosch NH₃ generation process is not sufficient for future needs of fertilizer production.

Alternatively, and as described herein, regular nourishment of soil with organic fertilizers made from humic-based nitrogen-sulfur substances (i.e., humnisul fertilizer) can aid in rejuvenating soils, thus enhancing the growth of plants.

Humic substances form the largest fraction of organic matter in soil and play a vital role in improving soil productivity and plant growth. Compared to peat and lignite-containing humic substances, coal is naturally abundant and enriched with humic substances (such as fulvic acid, humic acid, and humin fractions) that can be extracted in appreciable quantity for the fabrication of organic humnisul fertilizer from natural gas feedstocks.

According to the present disclosure, HNHS production from natural gas feedstocks is coupled with one or more humic substances from coal material to form the humnisul fertilizer described herein. HNHS natural gas feedstocks comprise large quantities of nitrogen species (e.g., N₂, NH₃, NH₂⁻, N₂⁺, and NH₄⁺) and sulfide species (e.g., H₂S/HS⁻, Sn₂⁻ and COS, CS₂, RS⁻) produced as side products during petroleum formation processes. These products, which are detrimental to hydrocarbon and natural gas production, can be captured and, in combination with organic humic substances, utilized for the production of low-cost, environmentally friendly, and sustainable fertilizer. Indeed, the humnisul fertilizer of the present disclosure provides efficient and economic management of HNHS hydrogen gas feeds (e.g., from sour reservoirs) and an environmentally friendly approach to curbing excessive H₂S emissions into the atmosphere during high sulfur (i.e., sour) hydrocarbon production to control acidic rain and related global warming scenarios.

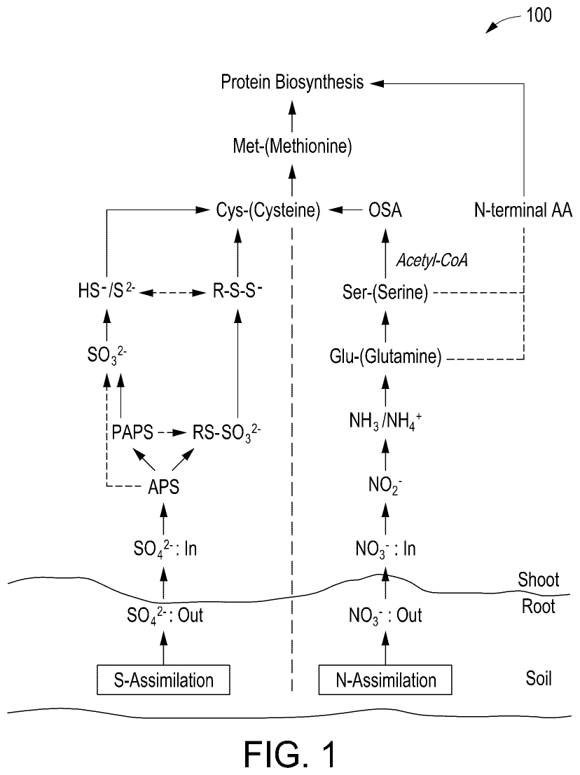

FIG. 1 illustrates the combined biochemical pathways of sulfur and nitrogen assimilation in plants for protein biosynthesis as described above.

The humnisul fertilizer of the present disclosure comprises a humic substance (including one or both of humic acid, fulvic acid, and humin) in the range of about 50 wt % to about 60 wt % of the total composition of the humnisul fertilizer, encompassing any value and subset therebetween, such as about 50 wt % to about 52 wt %, or about 52 wt % to about 54 wt %, or about 54 wt % to about 56 wt %, or about 56 wt % to about 58 wt %, or about 58 wt % to about 60 wt %. Excluding nitrogen and sulfur, humic substances comprise carbon, oxygen, and hydrogen.

The humnisul fertilizer comprises nitrogen in the range of about 11 wt % to about 14 wt % of the total composition of the humnisul fertilizer, encompassing any value and subset therebetween, such as about 11 wt % to about 12 wt %, or about 12 wt % to about 13 wt %, or about 13 wt % to about 14 wt %.

The humnisul fertilizer comprises sulfur in the range of about 15 wt % to about 17 wt % of the total composition of the humnisul fertilizer, encompassing any value and subset therebetween, such as about 15 wt % to about 16 wt %, or about 16 wt % to about 17 wt %.

The humnisul fertilizer may comprise minor components (elements) of hydrocarbon from the natural gas feedstock. These components may include, but are not limited to, dissolved organic CO₂ and CxHy species, in the range of about 0.1 wt % to about 1.85 wt %, encompassing any value and subset therebetween, such as about 0.1 wt % to about 0.4 wt %, or about 0.4 wt % to about 0.8 wt %, or about 0.8 wt % to about 1.2 wt %, or about 1.2 wt % to about 1.6 wt %, or about 1.6 wt % to about 1.85 wt %.

The humnisul fertilizer may comprise minor components (elements) associated with preparation of the humnisul fertilizer, such as iron. For example, iron may be present in the range of about 0.1 wt % to about 3 wt %, encompassing any value and subset therebetween, such as about 0.5 wt % to about 1 wt %, or about 1 wt % to about 0.5 wt %, or about 1.5 wt % to about 2 wt %, or about 2 wt % to about 2.5 wt %, or about 2.5 wt % to about 3 wt %.

The humnisul fertilizer may comprise an atomic ratio of oxygen to carbon (O/C) in the range of about 0.1 to about 0.8, encompassing any value and subset therebetween, such as about 0.1 to about 0.2, or about 0.2 to about 0.3, or about 0.3 to about 0.4, or about 0.4 to about 0.5, or about 0.5 to about 0.6, or about 0.6 to about 0.7, or about 0.7 to about 0.8.

The humnisul fertilizer may comprise an atomic ratio of hydrogen to carbon (H/C) in the range of about 0.05 to about 0.2, encompassing any value and subset therebetween, such as about 0.05 to about 0.1, or about 0.1 to about 0.15, or about 0.15 to about 0.2.

The humnisul fertilizer may comprise an atomic ratio of nitrogen to carbon (N/C) in the range of about 0.15 to about 0.3, encompassing any value and subset therebetween, such as about 0.15 to about 0.2, or about 0.25 to about 0.3.

The humnisul fertilizer may comprise an atomic ratio of sulfur to carbon (S/C) in the range of about 0.25 to about 0.4, encompassing any value and subset therebetween, such as about 0.25 to about 0.3, or about 0.3 to about 0.35, or about 0.35 to about 0.4.

The HNHS natural gas may comprise nitrogen in the range of about 5 mol % to about 15 mol %, encompassing any value and subset therebetween, such as about 5 mol % to about 7 mol %, or about 7 mol % to about 9 mol %, or about 9 mol % to about 11 mol %, or about 11 mol % to about 13 mol %, or about 13 mol % to about 15 mol %, or about 7 mol % to about 12 mol %.

The HNHS natural gas may comprise sulfur (e.g., hydrogen sulfide) in the range of about 8 mol % to about 15 mol %, encompassing any value and subset therebetween, such as about 8 mol % to about 9 mol %, or about 9 mol % to about 11 mol %, or about 11 mol % to about 13 mol %, or about 13 mol % to about 15 mol %, or about 7 mol % to about 12 mol %.

Other elements in the HNHS natural gas may include, but are not limited to, carbon dioxide, methane, ethane, propane, butanes, pentanes, hexanes, heptanes, octanes, nonanes, decanes, undecanes, dodecanes, and the like, and any combination thereof. Generally, light hydrocarbons are removed from the HNHS natural gas and processed as natural gas liquids and liquid natural gas, leaving about 0.1 wt % to about 1.85 wt % of these components, as described above, for use in the production of humnisul fertilizer.

The present disclosure further provides a method of preparing the humnisul fertilizer. The method comprises removing a plurality of humic substances from a coal extract; and reacting the removed plurality of humic substances with an HNHS hydrogen gas in the presence of an iron compound, thereby producing the humnisul fertilizer. The reaction conditions are described herein below with reference to the Examples.

The iron compound may be in the form of iron (II) acetate (FeOAc), for example, and may be included as part of the reaction to form the humnisul in the range of about 70 wt % to about 80 wt %, encompassing any value and subset therebetween, such as in the range of about 70 wt % to about 72 wt %, or about 72 wt % to about 74 wt %, or about 74 wt % to about 76 wt %, or about 76 wt % to about 78 wt %, or about 78 wt % to about 80 wt %. Additional iron compounds may include, but are not limited to, iron (II) chloride (FeCl₂), iron (II) sulfides (FeS), iron (II) amides (Fc₂(NH₂)₂), and any combination thereof, including any in combination with FeOAc. In one or more embodiments, the iron compound, alone or in combination with any of the aforementioned iron compounds may include, but is not limited to, FeS minerals, such as mackinawite (FeS), pyrrhotite (Fc₍₁₋ₓ₎S), and any combination thereof.

### Nonlimiting Example Embodiments

Embodiments disclosed herein include:

Embodiment A: A fertilizer composition comprising: humic substances derived from coal extracts; and a high-nitrogen/high-sulfur containing (HNHS) natural gas, wherein the humic substances are present in the range of about 50 wt % to about 60 wt % of the total fertilizer composition, wherein nitrogen is present in the range of about 11 wt % to about 14 wt % of the total fertilizer composition, and wherein sulfur is present in the range of about 15 wt % to about 17 wt % of the total fertilizer composition.

Embodiment A may have one or more of the following additional elements in any combination:
Element 1: wherein the humic substances are selected from the group consisting of humic acid, fulvic acid, and any combination thereof.
Element 2: wherein the fertilizer composition has an atomic ratio of oxygen to carbon (O/C) in the range of about 0.1 to about 0.8.
Element 3: wherein the fertilizer composition has an atomic ratio of hydrogen to carbon (H/C) in the range of about 0.05 to about 0.2.
Element 4: wherein the fertilizer composition has an atomic ratio of nitrogen to carbon (N/C) in the range of about 0.15 to about 0.3.
Element 5: wherein nitrogen is present in the HNHS containing natural gas in the range of about 5 mol % to about 15 mol %.
Element 6: wherein sulfur is present in the HNHS containing natural gas in the range of about 8 mol % to about 15 mol %.
Element 7: wherein the fertilizer composition further comprises an iron compound.
Element 8: wherein the fertilizer composition further comprises an iron compound, the iron compound being FeOAc.
Element 9: wherein the fertilizer composition further comprises an iron compound present in the range of about 0.1 wt % to about 3 wt % of the total fertilizer composition.
Embodiment A may have one, more, or all of Elements 1-9, without limitation.
Embodiment B: A method of preparing a fertilizer composition comprising: reacting humic substances derived from coal extracts with a high-nitrogen/high-sulfur (HNHS) containing natural gas in the presence of an iron compound, thereby producing the fertilizer composition.
Embodiment B may have, in addition to any one, more, or all of Elements 1-9, one or more of the following additional elements in any combination:
Element 10: further comprising deriving the humic substances from the coal extracts by extracting the humic substances using NaOH and purifying the extracted humic substances using a mixture of KOH and KCl.
Element 11: wherein the reacting is performed by homogenizing the humic substances and the HNHS containing natural gas.
Element 12: further comprising applying the fertilizer composition to a high pH, arid soil and growing plants therefrom.
Element 13: further comprising applying the fertilizer composition to a high pH, arid soil and growing plants therefrom, wherein the high pH is in the range of about 8 to about 11.
Element 14: further comprising applying the fertilizer composition to a high pH, arid soil and growing plants therefrom, wherein the plants are maize plants.
Element 15: wherein the iron component is FeOAc.
Embodiment B may have one, more, or all of Elements 1-15, without limitation.

### EXAMPLES

In the following examples, various experiments were performed and measurements taken to evaluate and validate the humnisul fertilizer of the present disclosure.

### Example 1

In this Example, humnisul fertilizer was prepared as follows.

Humic Substances: High purity lignite-containing coal was used as a source of humic substances. More specifically, the high purity lignite-containing coal was obtained from the Argonne Premium Coal Sample Program that originated from the North Dakota Beulah-Zap seam lignite bed. The lignite-containing coal was composed of three maceral groups in variable percentages: huminite (41-82%), inertinite (10-65%), and liptinite (4-13%).

Humic (HA) and fulvic acids (FA) were extracted from three lignite-containing coal samples, which were pulverized to 50-80 mesh. HA and FA were extracted following alkali extraction methods described by the International Humic Substance Society (IHSS) with modification using a batched stirred tank reactor (BSTR) set-up equipped with a double jacketed borosilicate glass and thermostatic temperature controller. 1.0 kg of pulverized lignite-containing coal was extracted with 6.0 L of 0.1 M NaOH (Sigma Aldrich) in the BSTR and operated at a temperature of 45° C. and a constant stirring speed of 1000 rpm for 5 hours under a constant stream of N₂ flow. After 5 hours of extraction, alkaline supernatant extracts were isolated by centrifugation (at 10,000 g for 12 min). The supernatants were acidified to pH=2.0 with 5.0 N HCl (Sigma Aldrich) at room temperature conditions to obtain coagulated HA and supernatant FA substances after sonication for 1 hour. The Humic substances were thereafter purified with a mixture of 0.1 M KOH (Sigma Aldrich) and 0.3 M KCl (Sigma Aldrich) and rotor evaporated to obtain a slurry comprising HAs and FAs. Quantitative elemental analyses of C˜H—N—O—S was performed using a LECO 932 Analyzer to confirm the quality and purity of the extracted HA and FA, which accounted for 76.1% of the extracts with atomic ratios (O/C, H/C, N/C, and S/C), and met IHSS standards. The results of the elemental analysis are shown in Tables 1, 2, and 3 for triplicate samples.

TABLE 1

| | Humic Substances | | |
|---|---|---|---|
| | % HA | % FA | Total Humic Extracts |
| Sample 1 | 64.3 | 15.8 | 80.1 |
| Sample 2 | 61.7 | 10.6 | 72.3 |
| Sample 3 | 63.1 | 12.7 | 75.8 |
| Average | 63.03 | 13.03 | 76.07 |

TABLE 2

| | Elemental Analysis | | | | |
|---|---|---|---|---|---|
| | % C | % H | % N | % S | % O |
| Sample 1 | 59.6 | 2.7 | 1.4 | 0.9 | 35.4 |
| Sample 2 | 61.0 | 3.5 | 2.5 | 0.7 | 32.3 |
| Sample 3 | 58.4 | 2.7 | 1.0 | 0.7 | 37.2 |
| Average | 59.67 | 2.97 | 1.63 | 0.77 | 34.97 |

TABLE 3

Atomic Ratios

| | O/C | H/C | N/C | S/C |
|---|---|---|---|---|
| Sample 1 | 0.594 | 0.045 | 0.023 | 0.015 |
| Sample 2 | 0.530 | 0.057 | 0.041 | 0.012 |
| Sample 3 | 0.637 | 0.046 | 0.017 | 0.012 |
| Average | 0.587 | 0.049 | 0.027 | 0.013 |

HNHS Natural Gas: HNHS natural gas containing high nitrogen (7.02-10.28 mol %) and high hydrogen sulfide (9.87-12.32 mol %) content were obtained from HNHS gases generated from the high thermal maturity zones of the Khuff reservoir, Saudi Arabia and placed into three 30 liter cylinders. Sulfide species (H₂S/HS; S²⁻, Sₙ²⁻, COS, CS₂, CH₃SH) and nitrogen impurities (N₂, NH₃, NH₂. NH₂⁺, and NH₄⁺) were removed from the HNHS natural gas feed using a modified Claus and Sulfrex system. Table 4 shows the contents (mol %) and molecular weight of the HNHS natural gas in each of the three cylinders by employing ASTM D-1945: Standard Test Method for Analysis of Natural Gas by Gas Chromatography and Gas Processors Association, GPA 2261: Analysis for Natural Gas and Similar Gaseous Mixtures by Gas Chromatography with slight modifications in sample injection size range (0.4-0.6 mL), temperature range (25° C.-60° C.), and helium carrier gas flow rate range (35 mL/min-90 mL/min).

TABLE 4

| Component | MW | Cylinder 1 | Cylinder 2 | Cylinder 3 |
|---|---|---|---|---|
| Nitrogen (N₂) | 28.01 | 10.28 | 12.21 | 7.02 |
| Carbon Dioxide (CO₂) | 44.01 | 2.11 | 1.76 | 1.39 |
| Hydrogen Sulfide (H₂S) | 34.10 | 9.87 | 10.02 | 12.32 |
| Methane (CH₄) | 16.04 | 38.64 | 48.75 | 37.33 |
| Ethane (C₂H₆) | 30.07 | 19.10 | 14.00 | 17.37 |
| Propane (C₃H₁₀) | 44.10 | 11.38 | 8.93 | 18.41 |
| i-Butane (C₄H₁₀) | 58.12 | 3.64 | 1.07 | 2.31 |
| n-Butane (C₄H₁₀) | 58.12 | 2.88 | 2.03 | 2.11 |
| i-Pentane (C₅H₁₂) | 72.15 | 1.50 | 0.55 | 1.24 |
| n-Pentane (C₅H₁₂) | 72.15 | 0.43 | 0.45 | 0.28 |
| Hexanes (C₆H₁₄) | 86.18 | 0.11 | 0.20 | 0.15 |
| Heptanes (C₇H₁₆) | 100.21 | 0.03 | 0.02 | 0.05 |
| Octanes (C₈H₁₈) | 114.23 | 0.02 | 0.01 | 0.01 |
| Nonanes (C₉H₂₀) | 128.20 | 0.01 | 0.00 | 0.01 |

The physical constants including, specific gravity (Air=1), gross heating value (BTU/SCF), pressure (psig), and temperature (° F.) for estimation of the various components in HNHS natural gas in each of the three cylinders is provided in Table 5, and the values were obtained from Gas Processors Association, GPA 2261: Analysis for Natural Gas and Similar Gaseous Mixtures by Gas Chromatography.

TABLE 5

| | Cylinder 1 | Cylinder 2 | Cylinder 3 |
|---|---|---|---|
| Specific Gravity | 1.3869 | 1.7402 | 1.902 |
| Gross Heating Value | 2,307 | 2,756 | 2,533 |
| Pressure | 810 | 703 | 817 |
| Temperature | 64 | 71 | 69 |

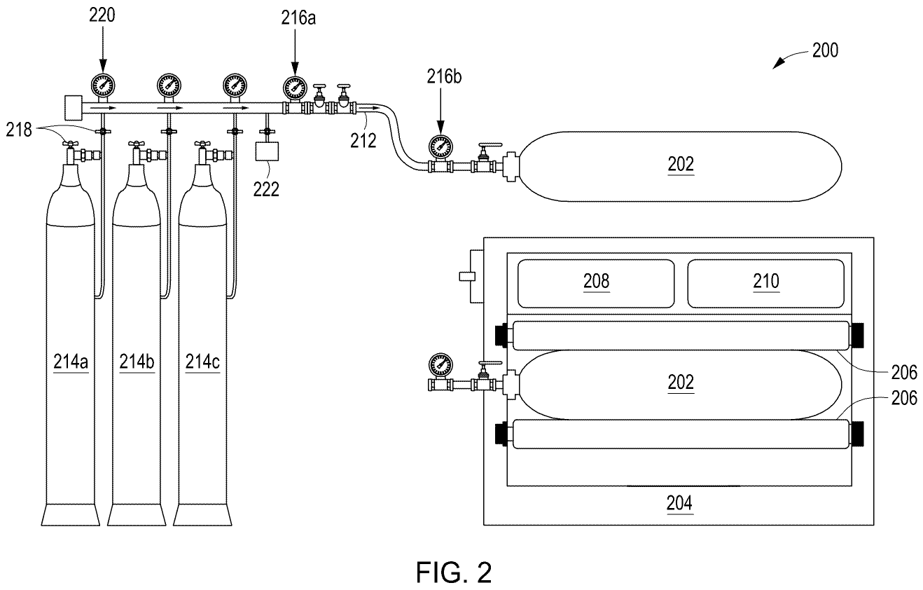

Humnisul Fertilizer Preparation: Referring now to FIG. 2, a Batch-scale laboratory system 200 was used to prepare the humnisul fertilizer. A 304 L high-pressure stainless steel Swagelock cylinder tank 202 was filled with 800 mL of the prepared humic substance slurry and 200 mL 2.5 M FeOAc (Sigma Aldrich). The contents in the cylinder were homogenized by setting on a thermostatic bottle rolling system 204 for 2 hours at room temperature. The thermostatic bottle rolling system 204 includes temperature control rollers 206, a rotor display 208, and a temperature display 210. After homogenization, the cylinder was removed from the thermostatic bottle rolling system 204 and connected to a vacuum pump (not shown) for 30 minutes to evacuate any non-condensable gasses.

The evacuated cylinder 202 was connected to gas transfer line 212, where it was charged slowly with HNHS natural gas for 5 hours received from three 30 L set stainless cylinders 214a, 214b, and 214c. To avoid any environmental and health exposure to high H₂S, two bourdon pressure gauges 216a and 216b were fitted along the transfer line 212 and were closely monitored for gas leakage. Each of the cylinders 214a, 214b, and 214c included a conduit connecting to the transfer line 212 and having a pressure regulator 218 and a pressure gauge 220. The transfer line further comprised a gas flow-rate controller 222.

Once the cylinder 202 was completely charged with with reactive sulfide and nitride components from the HNHS natural gas, it was removed from the transfer line 212 and placed on the thermostatic bottle rolling system 204 to undergo homogenization reaction for 6 hours at a temperature of 67° C. with the humic substances via, as is believed, sulfide incorporation and nitration medaited by iron (II) in aqueous phase from the FeOAc (Sigma Aldrich). Subsequently, the cylinder 202 was constantly rolled overnight (˜24 hours) on the thermostatic bottle rolling system 204 at 48° C. to yield a humnisul fertilizer slurry. The reaction was allowed to cool to room temperature and thereafter connected to a vacuum pump (not shown) for 3 hours to evacuate any non-condensable and unreacted gasses. The resultant humnisul fertilizer was observed to be brown/black in color and can be applied directly to plants as fertilizer in high pH, arid soil to support plant growth, such as pH in the range of about 8 to about 10, encompassing any value and subset therebetween, or higher, such as up to about 14. Alternatively, the humnisul fertilizer can be converted to a solid (cake) material by drying overnight in an oven at 45° C. for 72 hours, for example, and broken down by crushing and grinding into a fine powder for direct contact with plants as a fertilizer.

### Example 2

In this Example, the mechanism believed responsible for formation of the humnisul fertilizer is described.

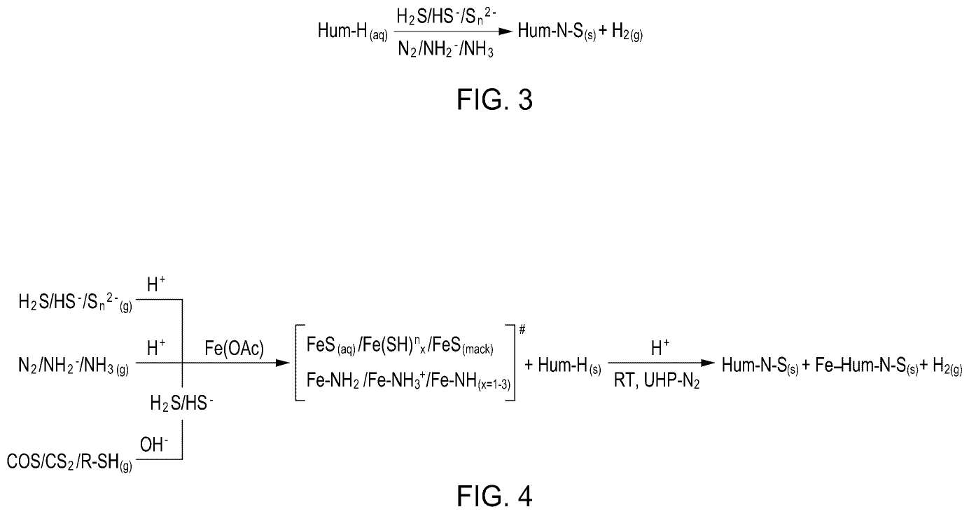

Without being bound by theory, it is believed that multiple reaction mechanisms serve as rate-limiting steps that control the humnisul fertilizer preparation process. First, direct nucleophilic addition or substitution reaction of small amounts of reactive sulfur (sulfide) and nitrogen species are believed to undergo an incorporation reaction with active sites of humic substance functional groups via combined sulfidation and nitration. These functional groups may include carboxyl, hydroxyl, phenolic, and thiol functional groups, for example. The believed reaction scheme is shown in FIG. 3, where Hum represents humic substance(s), N represents nitrogen, S represents sulfur, and H represents hydrogen.

After completion of the reaction shown in FIG. 3, it is believed that Iron (Fe)-mediated sulfide and nitride fixation occurs via chemisorption reaction pathways leading to the spontaneous formation and decomposition of metastable iron sulfides (FeS) and iron nitrides (Fe—NH₂) through protonation and hydrolysis processes. The believed reaction scheme is shown in FIG. 4. Again, without being bound by theory, it is believed that downstream decomposition of these metastable iron sulfide and iron nitride intermediates en-route to sulfides (H₂S/HS⁻, S₂⁻, Sₙ²⁻), ammonia (NH₃), and nitrides (NH₂⁺) release humic substance active functional groups to form organic-based humic nitrogen-sulfur fertilizer (humnisul fertilizer).

The schemes of FIGS. 3 and 4 demonstrate that at high N₂ pressure conditions, the presence of NH₃ in the natural gas streams or the formation of small NH₃ pressures in the experiments (e.g., Fe (N)→Fe(NH)→Fe(NH₂)→Fe(NH₃)) can enable the formation of iron nitride products (e.g., Fe (NHx), where x=1, 2, and 3) under reducing conditions.

### Example 3

In this example, properties of the humnisul fertilizer were evaluated.

Quantitative elemental analysis of C˜H—N—O—S of the prepared humnisul fertilizer described in Example 1 was performed using a LECO 932 Analyzer to confirm the quality and purity of the humnisul fertilizer. The results are shown in Tables 6 and 7.

TABLE 6

| | Elemental Analysis | | | | |
|---|---|---|---|---|---|
| | % C | % H | % N | % S | % O |
| Humnisul 1 | 51.1 | 4.9 | 13.6 | 17.9 | 12.5 |
| Humnisul 2 | 52.3 | 6.3 | 11.0 | 16.2 | 14.2 |
| Average | 51.7 | 5.6 | 12.3 | 17.1 | 13.4 |

TABLE 7

Atomic Ratios

| | O/C | H/C | N/C | S/C |
|---|---|---|---|---|
| Humnisul 1 | 0.245 | 0.096 | 0.266 | 0.350 |
| Humnisul 2 | 0.727 | 0.121 | 0.210 | 0.310 |
| Average | 0.259 | 0.109 | 0.238 | 0.330 |

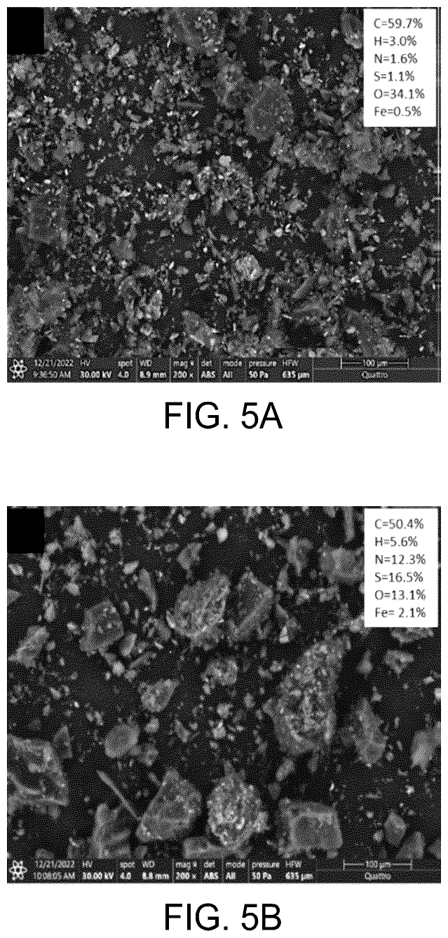

Morphological comparison of initial humic substance and the final humnisul product (after contact with HNHS hydrogen gas) was further evaluated by environmental scanning electron microscopy (ESEM) images with corresponding Energy-dispersive X-ray spectroscopy percentage elemental analyses (EDS). The results are shown in FIGS. 5A (initial) and 5B (final).

Differences in elemental composition between the LECO analysis of Table 6 and the EDS analysis of FIGS. 5A and 5B are believed to be due to Fe—Fe interactions, which is pronounced in the EDS analysis. More importantly, the reactivity of nitrogen and sulfide species incorporation into humic substances is promoted by the high adsorption capacity of the humic substances due to their chemical composition, crossed-linked macromolecular structures, molecular weight, and variety of functional groups (e.g., carboxyl, hydroxyl, phenolic, thiol, and other functional groups).

The results shown in Tables 6 and 7 and FIGS. 5A and 5B confirm the presence of sulfur and nitrogen fixation to humic substance in the humnisul fertilizer, which is believed to be mediated by aqueous phase Fe intermediate interactions with sulfides and nitrides, as described above with reference to FIG. 3. In summary, and as described hereinabove, the humnisul fertilizer comprises about 50% to about 60% of humic substances (humic and fulvic acid), about 11% to about 14% of nitrogen, about 15% to about 17% of sulfur containing compounds, and minor compounds of hydrocarbon and iron content.

### Example 4

In this Example, a pilot scale application of plant fertilization utilizing the humnisul fertilizer of Example 1 was evaluated.

The pilot scale application was conducted for ten weeks to explore the effects of the humnisul fertilizer on maize cultivation in high pH, arid soils to achieve balanced fertilization. As used herein, the term “balanced fertilizer” and “balanced fertilization,” and grammatical variants thereof, refers to a fertilizer and associated fertilization program that provides adequate, but not excessive, supplies of all plant nutrients to a soil.

In this Example, about 7.2 wt % to about 11.0 wt % of humnisul fertilizer was added to the high pH, arid soils, the pH of the soil being in the range of 8.3 to about 9.7.

Quantitative elemental analysis of C˜H—N—O—S atomic ratios of maize roots was determined using a LECO 932 Analyzer. Samples were taken of maize roots, dry weight of about 5 grams and studied at 6 weeks, 8 weeks, and 10 weeks after the maize was treated with humnisul fertilizer, compared to control maize that was not treated with humnisul fertilizer, to determine the influence of the humnisul fertilizer to root nutrient absorption. The atomic ratio results of the control maize are shown in Table 8 and the atomic ratio results of the humnisul fertilizer treated maize are shown in Table 9.

TABLE 8

Atomic Ratios

| | O/C | H/C | N/C | S/C |
|---|---|---|---|---|
| Control (6 wks) | 0.103 | 0.119 | 0.097 | 0.060 |
| Control (8 wks) | 0.081 | 0.111 | 0.091 | 0.090 |
| Control (10 wks) | 0.101 | 0.117 | 0.088 | 0.080 |
| Average | 0.095 | 0.116 | 0.092 | 0.077 |

TABLE 9

Atomic Ratios

| | O/C | H/C | N/C | S/C |
|---|---|---|---|---|
| Humnisul (6 wks) | 0.138 | 0.067 | 0.127 | 0.203 |
| Humnisul (8 wks) | 0.164 | 0.053 | 0.181 | 0.227 |
| Humnisul (10 wks) | 0.142 | 0.077 | 0.157 | 0.249 |
| Average | 0.148 | 0.066 | 0.155 | 0.226 |

As shown, the treated maize results correlate with C˜H—N—O—S ratios of the humnisul fertilizer (see Table 7) and demonstrate that the application of humnisul fertilizer has the ability to improve nutrients and promote the growth of plants in depleted high pH, arid soils as a balanced fertilization program.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A fertilizer composition comprising:
humic substances derived from coal extracts; and
a high-nitrogen/high-sulfur containing (HNHS) natural gas,
wherein the humic substances are present in the range of about 50 wt % to about 60 wt % of the total fertilizer composition,
wherein nitrogen is present in the range of about 11 wt % to about 14 wt % of the total fertilizer composition, and
wherein sulfur is present in the range of about 15 wt % to about 17 wt % of the total fertilizer composition.

2. The fertilizer composition of claim 1, wherein the humic substances are selected from the group consisting of humic acid, fulvic acid, and any combination thereof.

3. The fertilizer composition of claim 1, wherein the fertilizer composition has an atomic ratio of oxygen to carbon (O/C) in the range of about 0.1 to about 0.8.

4. The fertilizer composition of claim 1, wherein the fertilizer composition has an atomic ratio of hydrogen to carbon (H/C) in the range of about 0.05 to about 0.2.

5. The fertilizer composition of claim 1, wherein the fertilizer composition has an atomic ratio of nitrogen to carbon (N/C) in the range of about 0.15 to about 0.3.

6. The fertilizer composition of claim 1, wherein nitrogen is present in the HNHS containing natural gas in the range of about 5 mol % to about 15 mol %.

7. The fertilizer composition of claim 1, wherein sulfur is present in the HNHS containing natural gas in the range of about 8 mol % to about 15 mol %.

8. The fertilizer composition of claim 1, wherein the fertilizer composition further comprises an iron compound.

9. The fertilizer composition of claim 1, wherein the fertilizer composition further comprises an iron compound, the iron compound being FeOAc.

10. The fertilizer composition of claim 1, wherein the fertilizer composition further comprises an iron compound present in the range of about 0.1 wt % to about 3 wt % of the total fertilizer composition.

11. A method of preparing a fertilizer composition comprising:
reacting humic substances derived from coal extracts with a high-nitrogen/high-sulfur (HNHS) containing natural gas in the presence of an iron compound, thereby producing the fertilizer composition.

12. The method of claim 11, further comprising deriving the humic substances from the coal extracts by extracting the humic substances using NaOH and purifying the extracted humic substances using a mixture of KOH and KCl.

13. The method of claim 11, wherein the reacting is performed by homogenizing the humic substances and the HNHS containing natural gas.

14. The method of claim 11, further comprising applying the fertilizer composition to a high pH, arid soil and growing plants therefrom.

15. The method of claim 14, wherein the high pH is in the range of about 8 to about 11.

16. The method of claim 14, wherein the plants are maize plants.

17. The method of claim 11, wherein the fertilizer composition comprises:
humic substances in the range of about 50 wt % to about 60 wt % of the total fertilizer composition;
nitrogen in the range of about 11 wt % to about 14 wt % of the total fertilizer composition; and
sulfur in the range of about 15 wt % to about 17 wt % of the total fertilizer composition.

18. The method of claim 11, wherein the iron component is FeOAc.

19. The method of claim 11, wherein the humic substances are selected from the group consisting of humic acid, fulvic acid, and any combination thereof.
